(19) United States
(12) Patent Application Publication
(10) Pub. No.: US 2018/0166001 A1
(43) Pub. Date: Jun. 14, 2018

(54) DRIVING METHOD OF DISPLAY PANEL

(71) Applicant: Wuhan China Star Optoelectronics Technology Co., Ltd., Wuhan, Hubei (CN)

(72) Inventors: Yu-yeh CHEN, Shenzhen, Guangdong (CN); JhenWei HE, Shenzhen, Guangdong (CN); Xinhong CHEN, Shenzhen, Guangdong (CN); Yu WU, Shenzhen, Guangdong (CN)

(73) Assignee: Wuhan China Star Optoelectronics Technology Co., Ltd., Wuhan, Hubei (CN)

(21) Appl. No.: 15/112,411

(22) PCT Filed: Jun. 27, 2016
(86) PCT No.: PCT/CN2016/087256

§ 371 Date: Jul. 18, 2016

(30) Foreign Application Priority Data
May 30, 2016 (CN) 201610369992.4

(51) Int. Cl. G09G 3/20

(52) U.S. Cl. CPC G09G 3/2003; G09G 2330/021; G09G 2300/0439

(57) ABSTRACT

A driving method of a display panel including: providing a display panel including multiple data lines and pixel unit groups arranged in an array, each pixel unit group being divided into a first sub-pixel unit group and a second sub-pixel unit group alternately arranged along column direction, the first and the second sub-pixel unit groups each including multiple sub-pixels; in a same frame of image, the data lines scanning the first sub-pixel unit groups of the pixel unit groups; and driving signals on the data lines being performed with one time level switching and then the data lines scanning the second sub-pixel unit groups of the pixel unit groups. In the driving method of the invention, the level switching times of the driving signal on each data line is significantly decreased, the power consumption for driving the display panel can be reduced and display performance can be enhanced.

### CROSS REFERENCE TO RELATED APPLICATION

This application claims the priority of Chinese Patent Application No. 201610369992.4, entitled “Driving Method of Display Panel”, filed on May 30, 2016, the disclosure of which is incorporated herein by reference in its entirety.

### FIELD OF THE INVENTION

The invention relates to the field of display technology, and particularly to a driving method of a display panel.

### BACKGROUND OF THE INVENTION

Nowadays, in a UD tri-gate (Ultra High-Definition tri-gate) display panel, RGB three sub-pixels are vertically arranged, and a driving manner of a level switching for sub-pixels usually is a column inversion driving manner. The column inversion driving manner is shown in FIG. 1, where “+” represents a high level and “−” represents a low level. Sub-pixel units 40 in adjacent two rows have opposite source voltage level properties. That is, voltage level properties of the sub-pixel units 40 in adjacent two rows are different. Therefore, the level property of the source voltage needs to be periodically changed, for example, as far as a display panel with M rows and N columns sub-pixel units is concerned, the source voltage needs to be significantly changed with (M−1) times, which would greatly increase the power consumption of a source driving unit. Moreover, during pixels display a pure grayscale in such driving manner, pixel electrodes would always be at a high-frequency charging and discharging state, so that the pixel electrodes cannot be charged and discharged to optimum levels, thereby reducing display performance of the display panel.

### SUMMARY OF THE INVENTION

Accordingly, an objective of the invention is to provide a driving method capable of reducing power consumption of a display panel.

In order to achieve the above objective, embodiments of the invention provide technical solutions as follows.

The invention provides a driving method of a display panel. The driving method includes: providing a display panel, wherein the display panel includes multiple (i.e., more than one) data lines and pixel unit groups arranged in an array, each pixel unit group is divided into a first sub-pixel unit group and a second sub-pixel unit group alternately arranged along column direction, the first sub-pixel unit group and the second sub-pixel unit group each includes multiple sub-pixels; in a same frame of image, the data lines scanning the first sub-pixel unit groups of the pixel unit groups; and driving signals on the data lines being performed with one time level switching and then the data lines scanning the second sub-pixel unit groups of the pixel unit groups.

In an embodiment, the sub-pixels of each of the first sub-pixel unit group and the second sub-pixel unit group include sub-pixels with different colors, and each of the data lines scans the sub-pixels of each of the first sub-pixel unit group and the second sub-pixel unit group in a same color order.

In an embodiment, the sub-pixels of each of the first sub-pixel unit group and the second sub-pixel unit group specifically include a red sub-pixel, a green sub-pixel and a blue sub-pixel, and an order of each of the data lines scanning the sub-pixels of each of the first sub-pixel unit group and the second sub-pixel unit group is the blue sub-pixel, the red sub-pixel and the green sub-pixel in that sequence.

In an embodiment, the sub-pixels of each of the first sub-pixel unit group and the second sub-pixel unit group specifically include a red sub-pixel, a green sub-pixel and a blue sub-pixel, and an order of each of the data lines scanning the sub-pixels of each of the first sub-pixel unit group and the second sub-pixel unit group is the blue sub-pixel, the green sub-pixel and the red sub-pixel in that sequence.

In an embodiment, a level of the driving signal for scanning the first sub-pixel unit group is a high level, and a level of the driving signal for scanning the second sub-pixel unit group is a low level.

In an embodiment, each the data line sequentially scans multiple pixel unit groups in a corresponding column.

In an embodiment, after the data line scans one pixel unit group, the driving signal on the data line is performed with one time level switching and then the data line scans the next pixel unit group.

In an embodiment, after the data line scans the second sub-pixel unit group of the one pixel unit group, the driving signal on the data line is performed with one time level switching and then the data line scans the first sub-pixel unit group of the next pixel unit group.

The embodiments of the invention can achieve the following advantages or efficacy that a level property distribution of sub-pixels obtained by the driving method of a display panel as provided by the invention is same or similar to a level property distribution of sub-pixels obtained by the driving manner employed in the prior art, so that display effect obtained by the driving method of a display panel as provided by the invention is same or similar to display effect obtained by the driving manner in the prior art. Meanwhile, for the driving method of the invention, in a same frame of image, during one data line scans one pixel unit group, a level of a data line driving signal only is changed with one time. In the embodiments of the invention, the level switching times of the data line driving signal corresponding to each data line is significantly decreased, so that the power consumption for driving the display panel can be reduced. In addition, since there is no need of frequent switching of driving signal, charging and discharge effect of the pixel electrodes can be ensured and therefore display performance of the display panel is enhanced.

### BRIEF DESCRIPTION OF THE DRAWING

In order to more clearly illustrate technical solutions of embodiments of the invention or the prior art, drawings will be used in the description of embodiments or the prior art will be given a brief description below. Apparently, the drawings in the following description only are some of embodiments of the invention, the ordinary skill in the art can obtain other drawings according to these illustrated drawings without creative effort.

FIG. 1 is a schematic view of a column inversion driving manner for a display panel in the prior art.

FIG. 2 is a schematic structural view of a display panel according to the invention.

FIG. 3 is a schematic view of a signal change of a driving manner of the display panel as shown in FIG. 2.

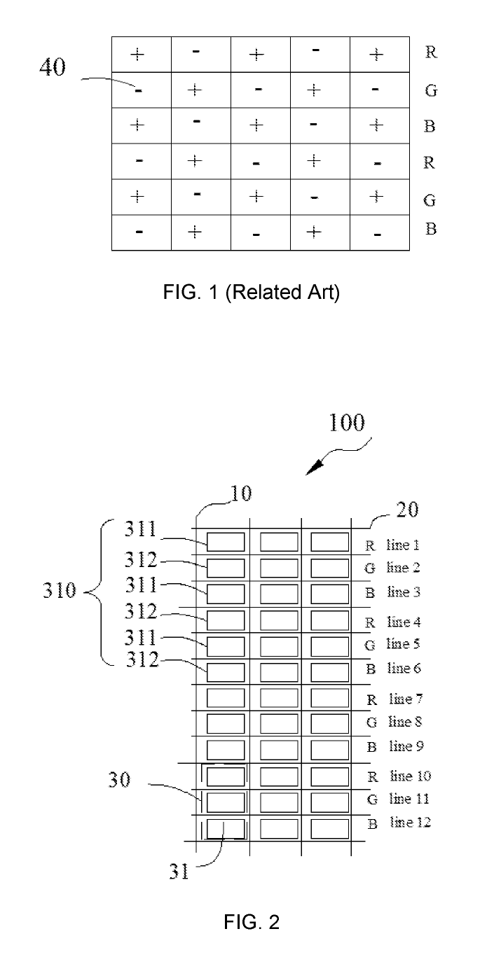

### DETAILED DESCRIPTION OF THE PREFERRED EMBODIMENT

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

An embodiment of the invention provides a driving method of a display panel. The driving method is adapted for driving a display panel as shown in FIG. 2. The display panel 100 includes multiple (i.e., more than one) data lines 10, multiple scan lines 20 and multiple pixel units 30. The pixel units 30 are arranged in an array. The data lines 10 are arranged crossing over the scan lines 20. Each data line 10 is corresponding to all the pixel units 30 in one column. Each pixel unit 30 includes multiple sub-pixels 31 arranged along column direction (i.e., generally lengthwise direction of data line). Adjacent two pixel units 30 in each column constitute one pixel unit group 310. In other words, the display panel 100 includes pixel unit groups 310 arranged in an array, and each data line 10 is corresponding to multiple pixel unit groups 310 in a same column. Multiple sub-pixels 31 in each pixel unit group 310 are divided into alternately arranged a first sub-pixel unit group 311 and a second sub-pixel unit group 312. It should be understood that, the first sub-pixel unit group 311 and the second sub-pixel unit group 312 each include multiple sub-pixels 31.

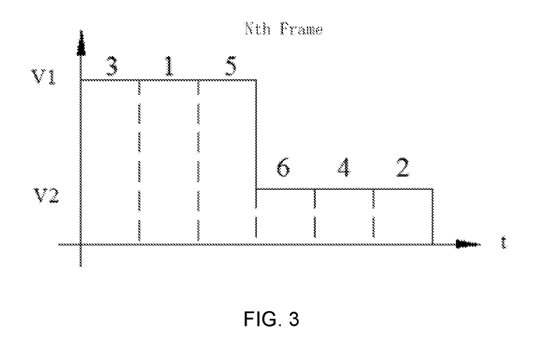

For the display panel 100 with the above-mentioned structure, please refer to FIG. 3. In FIG. 3, “V1” represents a high level, “V2” represents a low level, and numbers represent row numbers in FIG. 2. A driving method of the display panel 100 provided by the illustrated embodiment of the invention includes that: in a same frame of image, after the data lines 10 scan all the sub-pixels of the first sub-pixel unit groups 311 in the pixel unit groups 310, driving signals on the data lines 10 are performed with one time level switching, and then the data lines 10 scan all the sub-pixels of the second sub-pixel unit groups 312 in the pixel unit groups 310. It is noted that, the level switching in the invention ought to be performed in a same polarity, and thus the level switching only changes the value of voltage but does not change the polarity of voltage. That is, if an initial voltage is positive, a voltage after being performed with the level switching still is positive. Whereas, if the initial voltage is negative, the voltage after being performed with the level switching still is negative. It should be understood that, initial driving signal level properties (properties are high level and low level) on the data line 10 in adjacent two frames of image are opposite.

In a driving process of the display panel 100, level properties of initial data line driving signals corresponding to adjacent rows of sub-pixels 31 are opposite, so that the level properties of adjacent two sub-pixels 31 of each column are opposite. In a same frame of image, each data lines 10 sequentially scans all the sub-pixels of the first sub-pixel unit groups 311 of corresponding pixel unit groups 310 and then a driving signal on the data line 10 is performed with one time level switching, and afterwards the data line 10 scans all the second sub-pixel unit groups 312 of the corresponding pixel unit groups 310, so that in each pixel unit group 310, the level of the sub-pixels 31 in the first sub-pixel unit group 311 and the level of the sub-pixels 31 in the second sub-pixel unit group 312 have opposite properties. The level property distribution of the sub-pixels 31 obtained by the driving method of the display panel 100 provided by the illustrated embodiment of the invention is same or similar to the level property distribution of the sub-pixels 31 obtained by the driving method employed in the prior art, so that display effect obtained by the driving method of the display panel 100 provided by the invention is same or similar to display effect obtained by the driving method in the prior art. Meanwhile, for the driving method of the invention, in a same frame of image, during one data line 100 scans one pixel unit group 310, the level property of the driving signal on the data line only is changed one time. Compared with the prior art that a data line driving signal on each data line 10 for scanning one pixel unit group 310 requires the level property thereof to be switched three times, in the illustrated embodiment of the invention, the level switching times of the data line driving signal corresponding to each data line 10 is significantly decreased, and thereby reducing the power consumption for driving the display panel. In addition, since there is no need of frequent switching of driving signal, charging and discharging effect for pixel electrodes can be ensured, and therefore display performance of the display panel 100 is enhanced consequently.

In a preferred embodiment, each pixel unit 30 includes a red sub-pixel (R), a green sub-pixel (G) and a blue sub-pixel (B). The red sub-pixel, the green sub-pixel and the blue sub-pixel in each pixel unit 30 are sequentially arranged along column direction. It should be understood that, the sub-pixels in each of the first sub-pixel unit group 311 and the second sub-pixel unit group 312 include the red sub-pixel, the green sub-pixel and the blue sub-pixel. The sub-pixels 31 with different colors in the first sub-pixel unit group 311 and the second sub-pixel unit group 312 are alternately and cyclically arranged.

More specifically, referring to FIG. 2 and FIG. 3 together. Each data line 10 sequentially scans the sub-pixels with different colors in the first sub-pixel unit group 311 and the second sub-pixel unit group 312, and an order of the data line 10 scanning the sub-pixels in the first sub-pixel unit group 311 and the second sub-pixel unit group 312 is the blue sub-pixel, the red sub-pixel and the green sub-pixel in that sequence, or is the blue sub-pixel, the green sub-pixel and the red sub-pixel in that sequence. A concrete driving process is that: when the data line 10 scan one pixel unit group 310, the data line 10 firstly is applied with a high level to scan the sub-pixels in the first sub-pixel unit group 311 of the unit pixel group 310, a scanning order of the sub-pixels in the first sub-pixel unit group 311 is the blue sub-pixel, the red sub-pixel and the green sub-pixel in that sequence (or the blue sub-pixel, the green sub-pixel and the red sub-pixel in that sequence), and after completing/finishing the scanning process of the sub-pixels in the first sub-pixel unit group, a level of the driving signal on the data line 10 is switched and at this time the data line 10 is applied with a low level, afterwards the data line scans the sub-pixels in the second sub-pixel unit group 312, and a scanning order of the sub-pixels in the second sub-pixel unit group 312 is the blue sub-pixel, the red sub-pixel and the green sub-pixel in that order (or the blue sub-pixel, the green sub-pixel and the red sub-pixel in that order). At this point, the signal scanning for one pixel unit group 310 is completed. A reason of adopting such scanning order for sub-pixels is that: the naked eye has a low sensitivity to blue color, when the blue color is disposed at the switching point of the driving signal, the color uniformity can be ensured.

It is noted that, in a same frame of image, each data line 10 sequentially scans multiple pixel unit groups 310 in a corresponding column. In particular, after the data line 10 completes the scanning of the second sub-pixel unit group 312 in a preceding pixel unit group 310, the driving signal on the data line 10 is performed with one time level switching, and then the data line scans the first sub-pixel unit group 311 in a succeeding pixel unit group 310 and afterwards the driving signal on the data line 10 is performed with one time level switching again, and then the data line scans the second sub-pixel unit group 312 in the succeeding pixel unit group 310. After that, the driving signal on the data line 10 is performed with one time level switching still again, and subsequently repeats the above steps until the data line 10 completes the scanning of all pixel unit groups 310 in one column. It should be understood that, the number/amount of the sub-pixels in some of the first sub-pixel unit groups 311 and the number of the sub-pixels in the second sub-pixel unit groups 312 can be set according to actual situation, as long as the switching times of the data line driving signal corresponding to each data line 10 associated with the invention is less than the switching times of the data line driving signal corresponding to each data line 10 in the prior art.

It should be understood that, in a same row of sub-pixels, levels of adjacent two sub-pixels both may be a high level or a low level, or one is the high level and the other is the low level. Because it is not the focus of protection of the invention and thus there no detailed explanation is made herein.

In the description of the specification, reference to the term “one embodiment”, “some embodiments”, “an example”, “a specific example” or “some examples” etc., means that a particular characteristic, structure, material or feature described in the embodiment or example can be combined into at least one embodiment or example of the invention. In the specification, the exemplary expression of the above term does not necessarily mean the same example or example. Furthermore, the described particular characteristics, structures, materials or features may be combined in a suitable manner in any one or more embodiments or examples.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving method of a display panel, comprising: providing a display panel, wherein the display panel comprises a plurality of data lines and pixel unit groups arranged in an array, each of the pixel unit groups is divided into a first sub-pixel unit group and a second sub-pixel unit group alternately arranged along column direction, the first sub-pixel unit group and the second sub-pixel unit group each comprise a plurality of sub-pixels; in a same frame of image, the plurality of data lines scanning the first sub-pixel unit groups of the pixel unit groups; and driving signals on the plurality of data lines being performed with one time level switching and then the plurality of data lines scanning the second sub-pixel unit groups of the pixel unit groups.

2. The driving method of a display panel as claimed in claim 1, wherein the plurality of sub-pixels of each of the first sub-pixel unit group and the second sub-pixel unit group comprise sub-pixels with different colors, and each of the plurality of data lines scans each of the sub-pixels of the first sub-pixel unit group and the second sub-pixel unit group in a same color order.

3. The driving method of a display panel as claimed in claim 2, wherein the plurality of sub-pixels of each of the first sub-pixel unit group and the second sub-pixel unit group specifically comprise a red sub-pixel, a green sub-pixel and a blue sub-pixel, and an order of each of the plurality of data lines scanning the sub-pixels of each of the first sub-pixel unit group and the second sub-pixel unit group is the blue sub-pixel, the red sub-pixel and the green sub-pixel in that sequence.

4. The driving method of a display panel as claimed in claim 2, wherein the plurality of sub-pixels of each of the first sub-pixel unit group and the second sub-pixel unit group specifically comprise a red sub-pixel, a green sub-pixel and a blue sub-pixel, and an order of each of the plurality of data lines scanning the sub-pixels of each of the first sub-pixel unit group and the second sub-pixel unit group is the blue sub-pixel, the green sub-pixel and the red sub-pixel in that sequence.

5. The driving method of a display panel as claimed in claim 1, wherein a level of the driving signal for scanning the first sub-pixel unit group is a high level, and a level of the driving signal for scanning the second sub-pixel unit group is a low level.

6. The driving method of a display panel as claimed in claim 1, wherein each of the plurality of data lines sequentially scans a plurality of the pixel unit groups in a corresponding column.

7. The driving method of a display panel as claimed in claim 6, wherein after the data line scans one of the plurality of pixel unit groups, the driving signal on the data line is performed with one time level switching, and then the data line scans the next one of the plurality of pixel unit groups.

8. The driving method of a display panel as claimed in claim 7, wherein after the data line scans the second sub-pixel unit group of the one pixel unit group, the driving signal on the data line is performed with one time level switching, and then the data line scans the first sub-pixel unit group of the next pixel unit group.
